(19) United States
(12) Patent Application Publication
(10) Pub. No.: US 2026/0050539 A1
(43) Pub. Date: Feb. 19, 2026

(54) GENERATING TEST DATASETS FOR EVALUATING VIRTUAL AGENTS

(71) Applicant: Zendesk, Inc., San Francisco, CA (US)

(72) Inventors: Mariana Sá Correia Leite de ALMEIDA, Lisbon (PT); David Oliveira APARÍCIO, Porto (PT); Samuel David Pelaio ARCADINHO, Lisbon (PT)

(21) Appl. No.: 19/298,763

(22) Filed: Aug. 13, 2025

Related U.S. Application Data
(60) Provisional application No. 63/682,877, filed on Aug. 14, 2024.

(51) Int. Cl. G06F 11/3668

(52) U.S. Cl. CPC G06F 11/3684

(57) ABSTRACT

A method of generating a set of test datasets for evaluating large language model agents, the method including: extracting, using a large language model, application programming interfaces (APIs) associated with procedures for one or more target intents; generating, using the large language model, a flowgraph based on the APIs and the procedures for the one or more target intents; generating, using the large language model, a conversation graph based on the flowgraph; generating, using the large language model, conversations based on at least the conversation graph, the APIs, and a series of sampled paths from the conversation graph; and extracting the set of test datasets from the conversations.

### CROSS-REFERENCE TO RELATED APPLICATIONS

This Application claims the benefit of and priority to U.S. Provisional Ser. No. 63/682,877, filed on Aug. 14, 2024, the entire contents of which are hereby incorporated by reference.

### INTRODUCTION

### Technical Field

Aspects of the present disclosure relate to techniques for generating test datasets for evaluating large language model agents.

### Background

Companies are increasingly leveraging artificial intelligence (AI) tools, such as large language models (LLMs), to create and utilize virtual AI agents that are capable of having realistic conversations with users while following procedures and executing actions. For example, deployed virtual AI agents that leverage LLMs may include virtual AI assistants, customer support systems including chatbots, and various other customer-facing virtual agents. Accordingly, companies constantly strive to improve the effectiveness and veracity of deployed LLM agents.

### SUMMARY

One aspect provides a method of generating a set of test datasets for evaluating large language model agents, the method including: extracting, using a large language model, application programming interfaces (APIs) associated with procedures for one or more target intents; generating, using the large language model, a flowgraph based on the APIs and the procedures for the one or more target intents; generating, using the large language model, a conversation graph based on the flowgraph; generating, using the large language model, conversations based on at least the conversation graph, the APIs, and a series of sampled paths from the conversation graph; and extracting the set of test datasets from the conversations.

Another aspect provides, a non-transitory computer-readable medium storing program code for causing a processing system to perform a method, the method including: generating, using a large language model, procedures for one or more target intents; extracting, using the large language model, associated application programming interfaces (APIs) based on the generated procedures; generating, using the large language model, based on the extracted APIs and the generated procedures, a flowgraph; generating, using the large language model, a conversation graph based on the generated flowgraph; generating, using the large language model, conversations based on at least the conversation graph, the extracted APIs, and a series of sampled paths from the generated conversation graph; and extracting at least one test dataset from the generated conversations.

Other aspects provide processing systems configured to perform the aforementioned method as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts exemplary system architecture for generating test datasets for evaluating LLM agents according to at least one embodiment.

FIG. 2 depicts an exemplary automated test dataset generation pipeline for generating test datasets for evaluating LLM agents according to at least one embodiment.

FIG. 3 depicts an exemplary operational flowchart for a process of generating test datasets for evaluating LLM agents according to at least one embodiment.

FIG. 4 depicts an exemplary flowgraph that may be generated by an illustrative process of generating test datasets for evaluating LLM agents according to at least one embodiment.

FIG. 5 depicts an exemplary conversation graph that may be generated by an illustrative process of generating test datasets for evaluating LLM agents according to at least one embodiment.

FIG. 6 depicts an exemplary algorithm for conversation path sampling usable with an illustrative process of generating test datasets for evaluating LLM agents according to at least one embodiment.

FIGS. 7A-1 and 7A-2 depict a set of exemplary prompts that may be input into a large language model to perform given steps of the exemplary operational flowchart of FIG. 3 according to at least one embodiment.

FIG. 7B depicts exemplary prompts that may be input into a large language model to perform given steps of the exemplary operational flowchart of FIG. 3 according to at least one embodiment.

FIGS. 7C-1, 7C-2, and 7C-3 depict a set of exemplary prompts that may be input into a large language model to perform given steps of the exemplary operational flowchart of FIG. 3 according to at least one embodiment.

FIGS. 7D-1, 7D-2, and 7D-3 depict a set of exemplary prompts that may be input into a large language model to perform given steps of the exemplary operational flowchart of FIG. 3 according to at least one embodiment.

FIGS. 7E-1, 7E-2, and 7E-3 depict a set of exemplary prompts that may be input into a large language model to perform given steps of the exemplary operational flowchart of FIG. 3 according to at least one embodiment.

FIG. 8 depicts an exemplary test extraction scheme for an illustrative process of generating test datasets for evaluating LLM agents according to at least one embodiment.

FIG. 9 depicts an exemplary processing environment in which a system for generating test datasets for evaluating LLM agents according to at least one embodiment may be implemented.

FIG. 10 depicts a table of evaluation results for a series of LLMs employed as LLM agents using test datasets generated via an illustrative process of generating test datasets for evaluating LLM agents according to at least one embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments of the present disclosure are directed to methods, processing systems, and computer-readable mediums for generating test datasets for evaluating large language model agents. As previously discussed, companies are increasingly leveraging artificial intelligence (AI) tools, such as large language models (LLMs), to create and utilize virtual AI agents that are capable of having realistic conversations with users while following procedures and executing actions. For example, deployed virtual AI agents that leverage LLMs may include virtual AI assistants, customer support systems including chatbots, and various other customer-facing virtual agents. Accordingly, companies constantly strive to improve the effectiveness and veracity of deployed LLM agents.

Improving the effectiveness and veracity of deployed LLM agents typically involves the use of test datasets to evaluate performance. Companies often seek to evaluate the performance of LLM agents before deploying them to interact with actual users. However, evaluation of LLM agents poses a significant challenge, as proper evaluation of LLMs in the context of human interaction or conversational dialogues is often difficult. Current approaches to evaluating LLMs focus on specific tasks, such as multi-question answering or code generation, which does not directly align with the broader sets of capabilities typically desired when assessing an LLM for applications like virtual agents or customer support systems. Furthermore, effective evaluation of LLM agents is facilitated by having high-quality test datasets. Obtaining high quality training datasets before deployment may involve significant manual efforts. Alternatively, companies may rely upon crude generation of conversations by LLMs. However, LLMs have a tendency to hallucinate content that is not grounded in relevant input procedures. Therefore, it would be advantageous to provide for automated methods of generating test data sets for LLM agents that may be used to properly evaluate LLM agents before they are deployed.

Accordingly, methods, processing systems, and computer-readable mediums for generating test datasets for evaluating large language model agents are provided. Embodiments described herein provide a framework that automatically generate test datasets by prompting a given LLM to generate series of intermediate graph structures, such as flowgraphs and conversations graphs, that are directly related to a target intent, relevant procedures, and extracted APIs corresponding to the relevant generated procedures. This allows described embodiments to generate improved test datasets that may help limit the LLM's tendency to hallucinate content that may not be grounded in input procedures. Some embodiments may further include a noise generator that insert noise corresponding to unexpected customer behavior that goes outside of the initially generated procedures. This results in the generation of test datasets that mimic real-world use cases and conversational tendencies to provide for improved ability to evaluate the resilience of the LLM engaging with the generated training datasets. Some embodiments may further leverage a text extractor to break down each generated conversation into multiple sub-conversations, each of which may function as an individual test dataset. Furthermore, described embodiments provide a flexible pipeline having specific parts or steps which may be ablated to insert existing knowledge (e.g., existing procedures or APIs) as may be useful for a given user. This provides improved flexibility and customizability for generating high-quality test datasets for evaluating a given LLM agent.

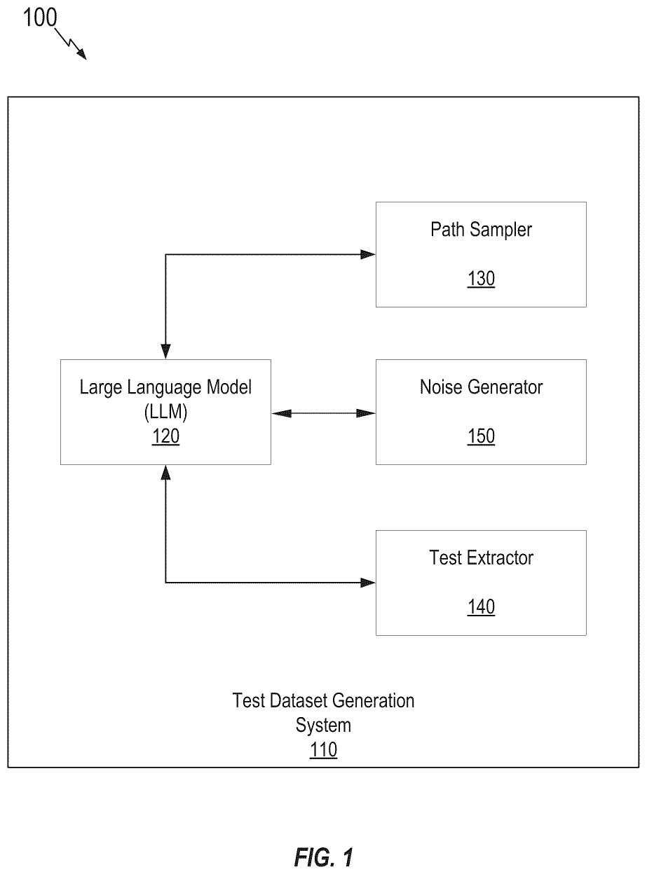

Turning to FIG. 1, an exemplary system architecture 100 for implementing an exemplary test dataset generation system 110 is depicted. Exemplary system architecture 100 may be implemented as a system on one or more computing devices within a local network (e.g., a local area network (LAN)) or a distributed system on a plurality of computing devices on multiple networks in data communication with one another (e.g., a wide area network (WAN), Internet, or the like).

Exemplary system architecture 100 of test dataset generation system 110 may include a large language model (LLM) 120. LLM 120 may be an off-the-shelf machine learning model, such as an off-the-shelf LLM or, optionally, a fine-tuned machine learning model that has been trained to generate suggested responses to customer requests (e.g., a fine-tuned LLM). LLM 120 may include, for example, OpenAI's ChatGPT, NeMO™ LLM from NVIDIA®, LLaMa from Meta®, BERT from Google®, CLAUDE™ from Anthropic A.I., and FLAN-T5 form Google®. Described embodiments may implement one or more LLMs currently developed or that may be developed in the future. When an LLM is used, the LLM may be or incorporate, among other information, a prompt to be utilized to generate the suggested responses. In some examples, the LLM 120 may be or include a machine learning system or module that includes a plurality of machine learning models. While some example systems and methods described herein implement large language models, alternative examples of systems and methods in accordance with this disclosure may implement any alternative type of generative model capable of performing techniques described herein to generate test datasets for evaluating agents. In some examples, LLM 120 may be replaced with a small transformer-based model trained on a limited corpora to be optimized for specific tasks associated with a given agent. As used herein, a “small transformer-based model” may refer to any model trained using a billion or less tokens and having a parameter count (e.g., an adjustable weight or bias adjusted during training) below 1 billion.

To initiate a LLM to perform an operation, generally, a prompt needs to be provided to the LLM. LLMs are a type of artificial intelligence model that have been trained through deep learning algorithms to recognize, generate, translate, and/or summarize vast quantities of written human language and textual data based on user input. A prompt is an input to which the LLM is meant to respond. Prompts can include instructions, questions, or any other type of input, depending on the intended use of the LLM. Prompts play a critical role in obtaining optimal results from the LLM, and how a prompt is written can affect the output that is generated. Accordingly, carefully designed prompts, referred to herein as an engineered prompts, are developed to generate desired outputs. The prompt is engineered so as to elicit an abstractive description of the intent. LLM 120 of test dataset generation system 110 may be configured to receive prompts from a user through any suitable known interfaces and platforms. For example, LLM 120 may be configured to receive prompts from a user or developer through an application programming interface (API), a software development kit (SDK), command line interfaces (CLIs), integrated development environment (IDE) plugins, custom middleware, web-based interactive consoles, or any other suitable known methods for sending prompts to LLM 120. Described embodiments may leverage LLM 120 to perform various functions, as will be described in greater detail below.

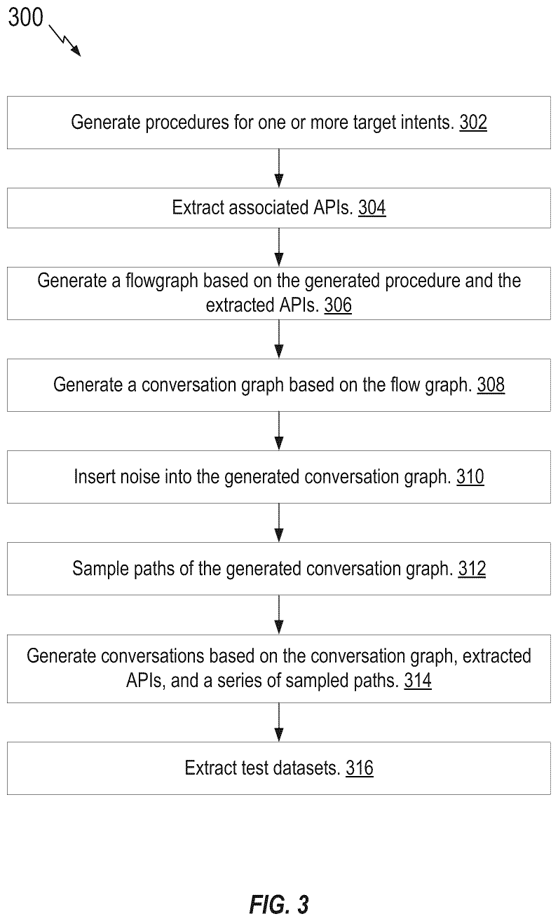

Exemplary system architecture 100 may further include a path sampler 130. In embodiments, path sampler 130 may be configured to execute an algorithm configured to sample paths of a generated conversation graph, as will be described in greater detail below. Exemplary system architecture 100 may further include a noise generator 150. In embodiments, noise generator 150 may be configured to insert noise into the generated conversation graphs. Exemplary system architecture 100 may also include a test extractor 140 configured to extract test datasets from conversations generated by LLM 120. Path sampler 130 and test extractor 140 will be described in greater detail below in connection with the illustrative process of generating test datasets for evaluating LLM agents shown in FIG. 3. As used herein, “LLM agents” refer to any software-based systems designed to interact with users that utilize large language models as a computational component. Typically, LLM agents interact with users through text or voice, using methods representative of human conversation. LLM agents may be designed for a variety of end uses related to understanding natural language, generating human-like text, interacting with users, making decisions, and performing tasks. For example, LLM agents may function as artificial intelligence powered chatbots configured to answer questions, retrieve information, generate code, summarize content, and assist users in a variety of ways.

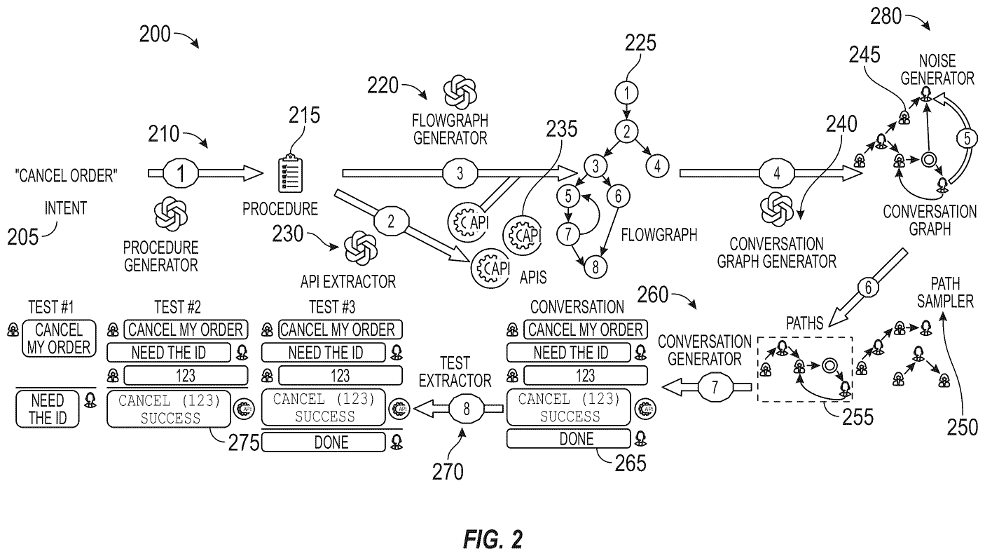

FIG. 2 depicts an exemplary automated test dataset generation pipeline 200 employable by an exemplary test dataset generation system 110 for generating test datasets for evaluating LLM agents according to at least one embodiment. Automated test dataset generation pipeline 200 may begin with a procedure generator 210 generating procedures 215 based on a series of intents 205. In some embodiments, a set of procedures may alternatively be provided to test dataset generation system 110. For example, a user or system may provide test dataset generation system 110 with an already existing set of domain-specific procedures for a given domain. An API extractor 230 may then extract APIs 235. In some examples, the APIs 235 are extracted by prompting an LLM to generate and return a set of APIs useful for a seed procedure. In some examples, a set of APIs may instead be provided to test dataset generation system 110. For example, a user or system may provide an already existing set of APIs related to a given domain. Next, a flowgraph generator 220 may leverage the extracted APIs 235 and the procedures 215 to output a flowgraph 225. A conversation graph generator 240 may then convert the flow graph into a conversation graph 245. In some embodiments, a noise generator 280 may insert noise into the conversation graph 245. Then, a path sampler 250 may sample paths of the conversation graph 245 to extract a series of paths 255. In embodiments, the path sampler 250 may sample paths of the conversation graph 245 using random walks. In alternative embodiments, the path sampler 250 may sample paths of the conversation graph 245 by executing an algorithm, as will be discussed in greater detail below. A conversation generator 260 may then generate conversations 265 based on the paths 255. Thereafter, a test extractor may extract one or more tests 275 from conversations 265. Tests 275 may be compiled to generate larger test datasets that may be used to evaluate or further train a given LLM agent.

While various pipeline components are depicted in FIG. 2, it should be understood that the individual components of FIG. 2 may have functionality performable by certain architectural components, such as the components of exemplary system architecture 100 of FIG. 1. For example, in embodiments, LLM 120 of FIG. 1, may functionally serve as one or more of procedure generator 210, flowgraph generator 220, API extractor 230, conversation graph generator 240, or conversation generator 260. Exemplary automated test dataset generation pipeline 200 will be referenced and discussed in greater detail below in connection with the description of FIG. 3.

FIG. 3 depicts an exemplary process 300 of generating test datasets for evaluating LLM agents that may be carried out by an exemplary test dataset generation system 110 according to at least one embodiment. It may be understood the LLM (see LLM 120 of FIG. 1) carries out steps of process 300 in response to receiving one or more prompts. Illustrative prompts usable when performing process 300 are discussed in greater detail below.

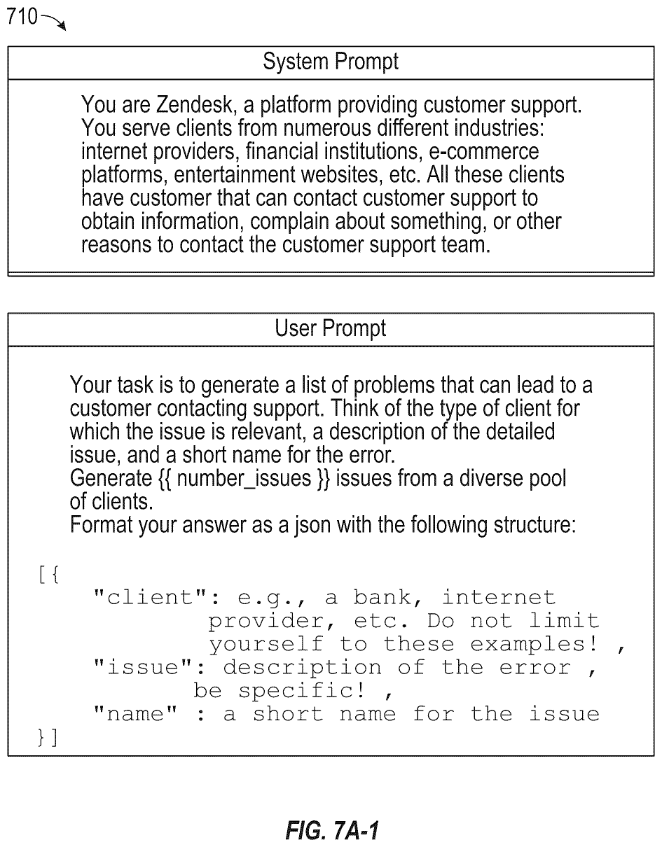

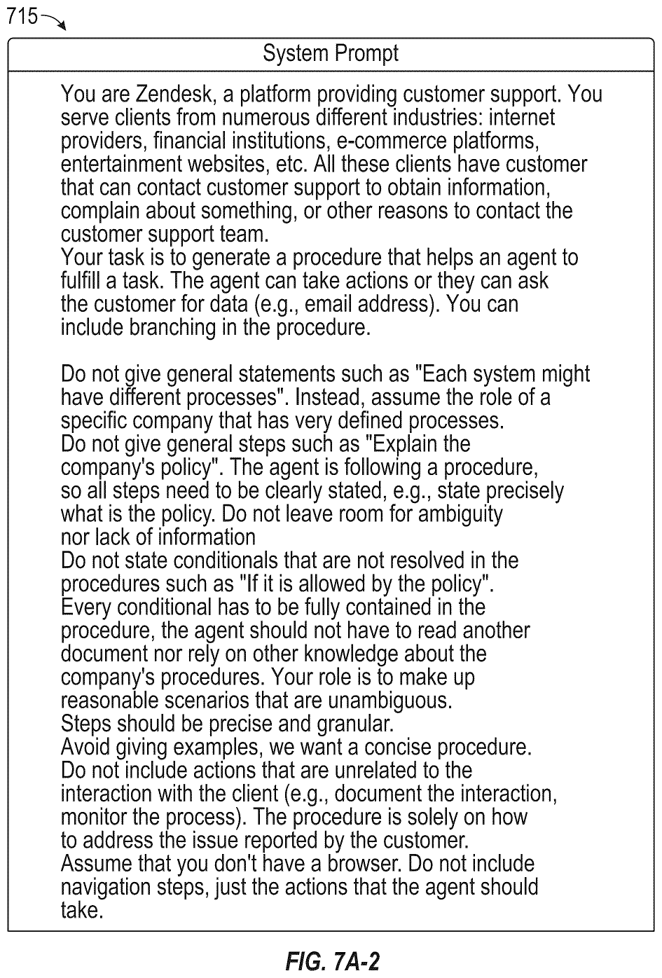

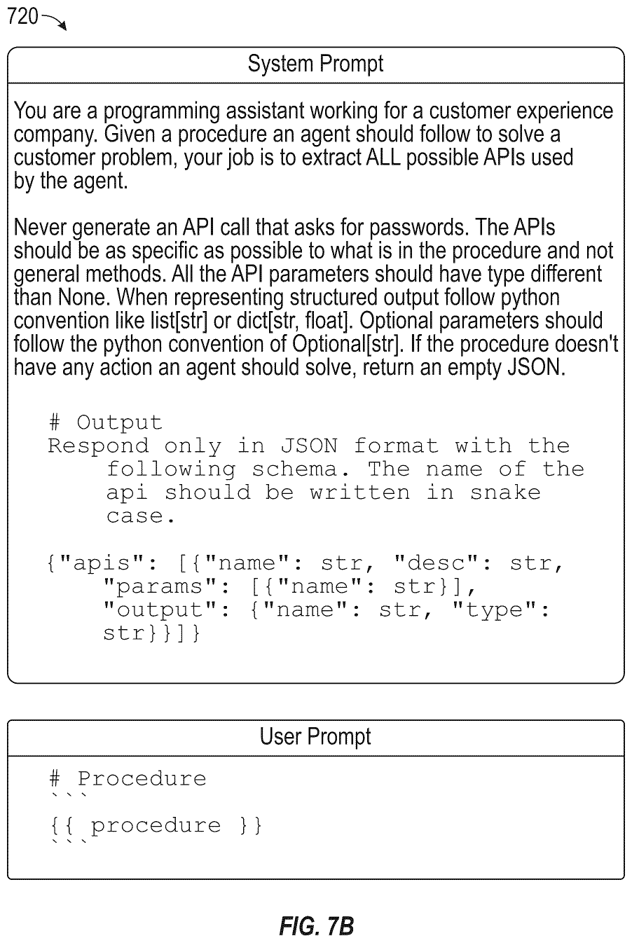

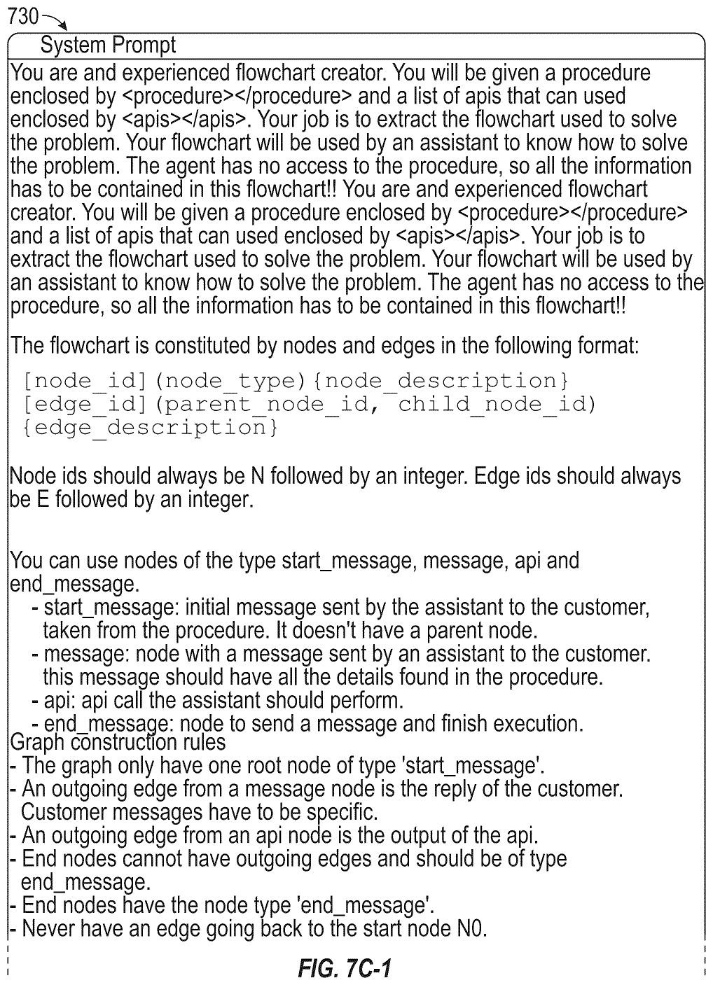

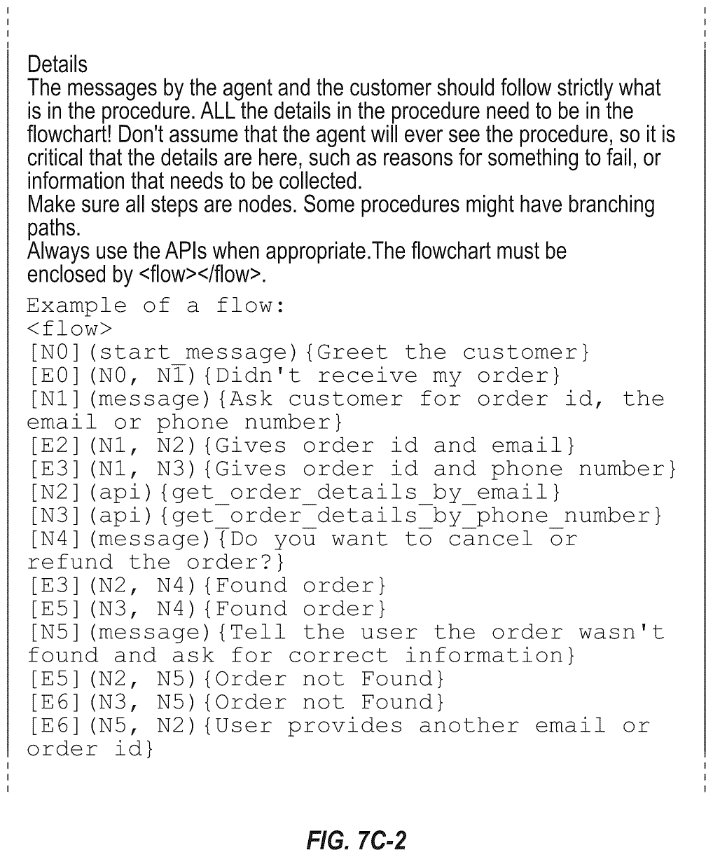

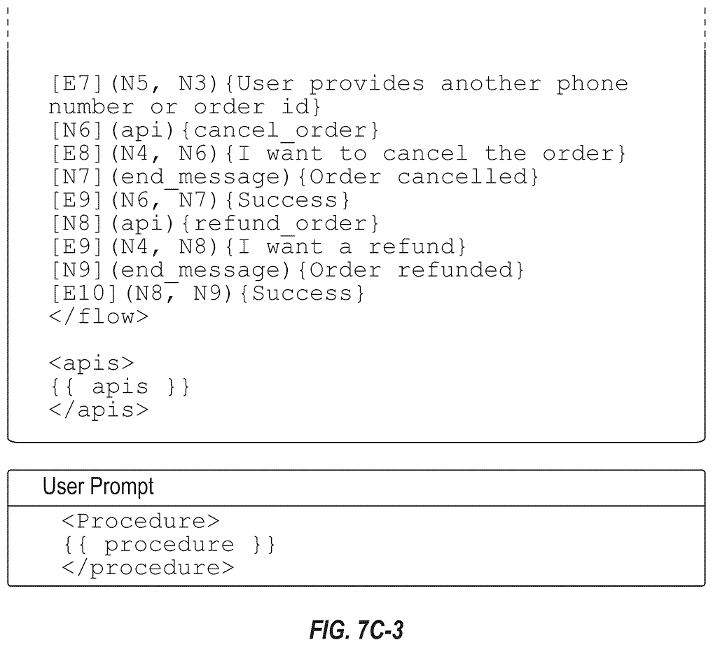

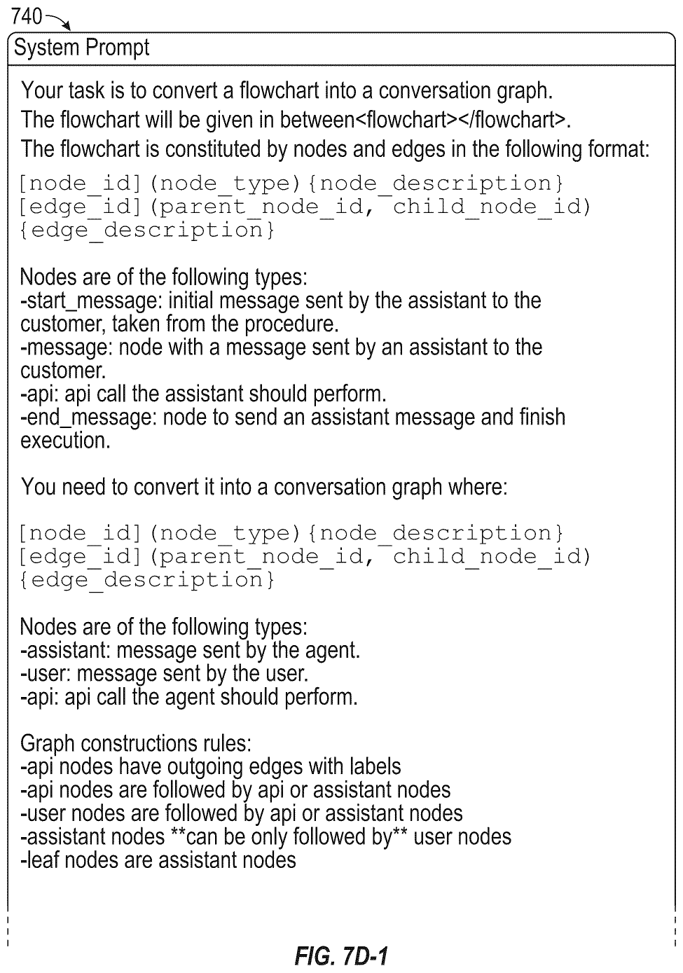

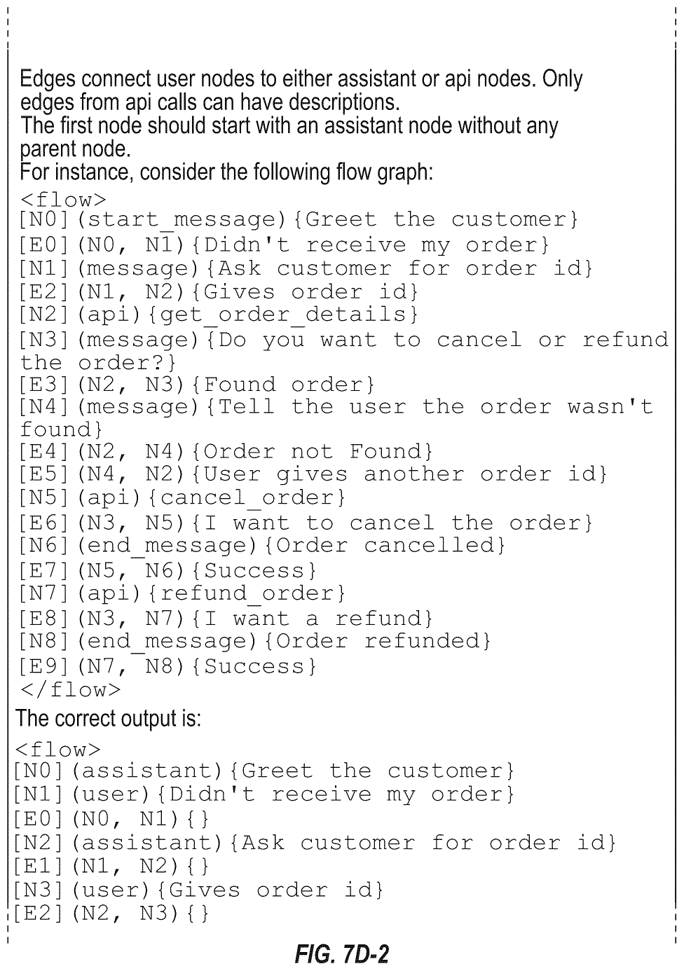

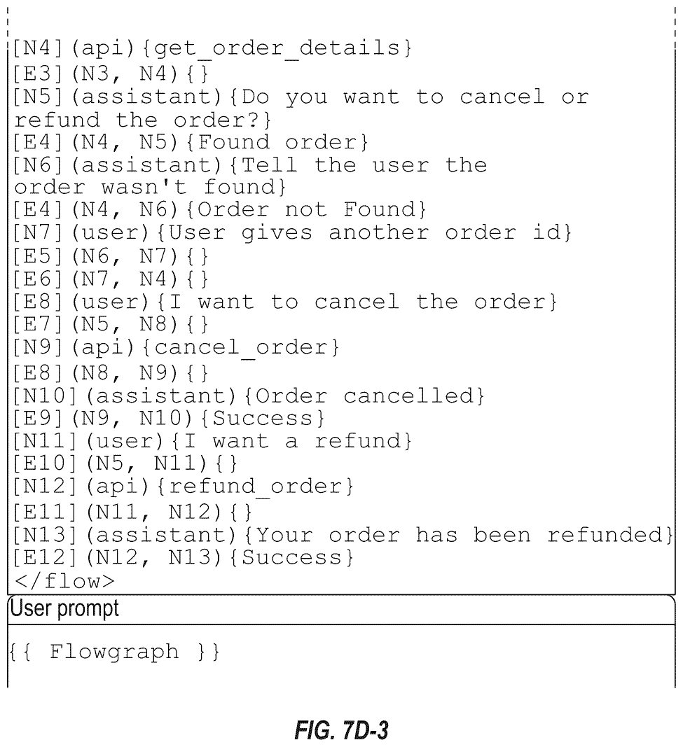

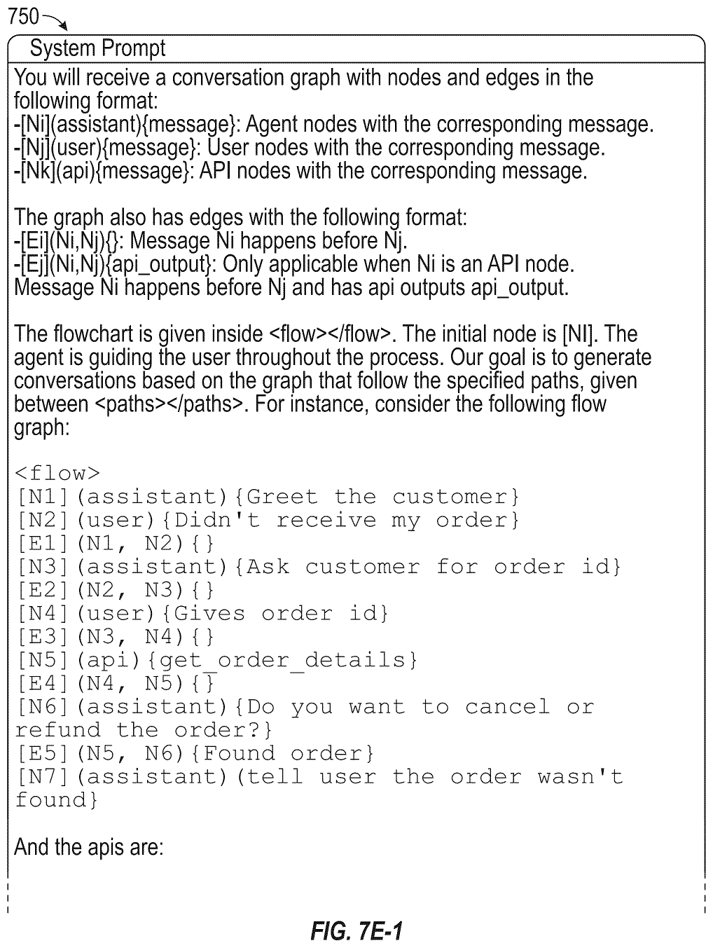

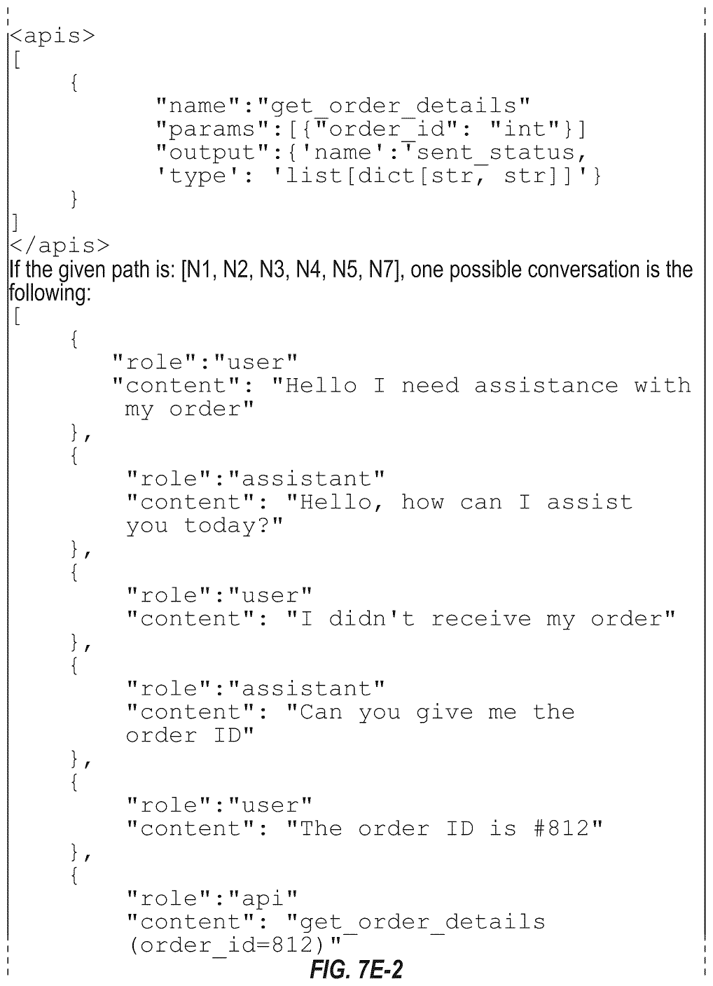

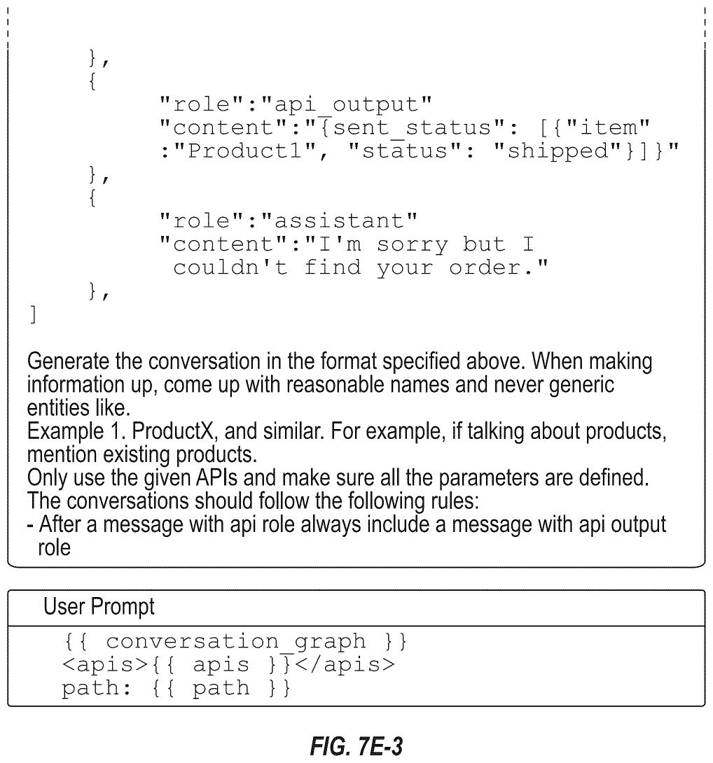

At block 302, test dataset generation system 110 generates, using an LLM, procedures for one or more target intents. In some examples, the target intents may come from a set of predefined intents from a specific domain, may be generated by an LLM or may come from a mixture of both. Referring back to the exemplary automated test dataset generation pipeline 200 (See FIG. 2), the LLM used by test dataset generation system 110 may function as a procedure generator (such as procedure generator 210 in FIG. 2) to generate a series of procedures for a set of target intents (such as intents 205) provided to the language model within a prompt usable to generate the set of procedures. In embodiments, the generated procedures may include a list of instructions which help an associated LLM agent fulfill a given task. FIG. 7A-1 depicts a first exemplary prompt 710 for using an LLM to generate a series of target intents, while FIG. 7A-2 depicts a second exemplary prompt 715 for using an LLM to generate a series of procedures based on the target intents. The quality and features of the generated procedures are reflective of the prompt that is input into the LLM. In embodiments, an exemplary prompt for generating procedures, such as second prompt 715, may include enforceable limitations instructing the LLM to avoid outputting general statements (e.g. “cancelling an order might be different depending on the system” or “explain the company's policy”). In embodiments, input prompts may include conditions or enforceable limitations to generate specific and unambiguous procedures that include granular steps that are specific. In embodiments, prompts may enforce conditional actions that are possible, but only if the conditional actions have clear solutions or steps within the generated procedure. In some embodiments, certain procedures and scripts may be generated based on existing knowledge. For example, certain procedures or scripts may be generated if a given domain includes existing tickets or help center articles that may be considered.

Notably, in some examples, a set of procedures for a corresponding set of target intents may alternatively be provided to the test dataset generation system (and employed LLM), thereby enabling the test dataset generation system to begin process 300 at block 304 rather than relying upon the LLM to generate the set of procedures. For example, a user or system may provide test dataset generation system 110 with an already existing set of domain-specific procedures for a set of target intents associated with a given domain. In some examples, the test dataset generation system may then incorporate the provided set of procedures and corresponding target intents within a prompt usable to cause the large language model to extract a set of APIs for the set of procedures, as will be described in greater detail below.

At block 304, test dataset generation system 110 extracts, using the LLM, APIs associated with the generated procedures. An API associated with a generated procedure may, for example, include any API that is called by a given agent to fulfill the procedure. In embodiments, the extracted APIs may be subsequently useful for a seed procedure. In some embodiments, a set of APIs may be provided to test dataset generation system 110. For example, a user or system may provide, to test dataset generation system 110, an already existing set of APIs related to a given domain. Referring back to the exemplary automated test dataset generation pipeline 200 (See FIG. 2), the LLM used by test dataset generation system 110 may function as an API extractor (such as API extractor 230 in FIG. 2) to extract (e.g., generate) a series of APIs (such as APIs 235). FIG. 7B depicts an exemplary prompt 720 for using the LLM to extract APIs (e.g., usable by an agent for assisting a customer with a given procedure). In embodiments, an exemplary prompt for instructing the LLM to extract APIs may enforce that the APIs are agent APIs. In other words, the input prompt may ensure that the extracted APIs may not include customer-facing APIs. In embodiments, the extracted APIs include, not only the API name, but also their input output parameters, as well as a short description. In embodiments, the prompt may be designed to ensure that the extracted APIs are explicitly callable by the LLM agent to fulfill the generated procedure from block 302.

At block 306, test dataset generation system 110 generates, using the LLM, and based on the extracted APIs and the generated procedures, a flowgraph. Referring back to the exemplary automated test dataset generation pipeline 200 (See FIG. 2), the LLM used by test dataset generation system 110 may function as a flowgraph generator (such as flowgraph generator 220 in FIG. 2) to generate a flowgraph based on the generated procedure and extracted APIs. The generated flowgraph provides a structured representation of the generated procedures from block 302 of process 300. In embodiments, the flowgraph is a directed graph encapsulating the logic of the generated procedure. In embodiments, for example, the generated flowgraph may include nodes representing LLM agent actions, and edges representing reactions or answers from another entity, such as users or an API output. In embodiments, there may be nodes of at least four different types, which may include at least: (i) a single “start_message” node representing an initial message sent from the LLM agent to a customer; (ii) “message nodes” representing messages sent from the LLM agent to a customer; (iii) “API nodes” representing API calls that the agent should perform; and (iv) “end_message” nodes representing messages by the LLM agent that end an interaction.

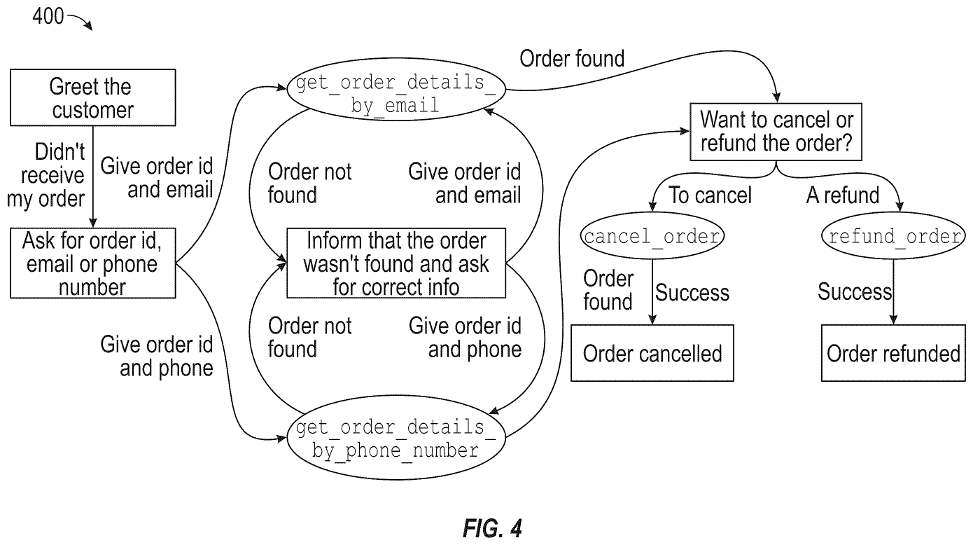

FIG. 4 depicts an exemplary flowgraph 400 that may be generated by an illustrative process of generating test datasets for evaluating LLM agents according to at least one embodiment. In embodiments, it may be enforced in the prompt that all details from the generated procedure will be included in the message nodes. By ensuring the flowgraph is generated based on the generated procedures and the extracted APIs, the resulting output will include less hallucinations and increased completeness with respect to being grounded in the procedure, increasing the likelihood of successful resolving of a given customer's or user's issue or intent. In embodiments, nodes in a given flowgraph may include a “node_id” (e.g. “N1”) a “node_type” (e.g. “start_message”, “API nodes”, etc.), a “node_description” which may be related to given steps in the generated procedure (e.g. “Tell the user the order was not found”), or an API_call (e.g. “refund_order”). In embodiments, edges in the flowgraph may be either user interactions (e.g. “Gives order id and email”), or the result of an API call (e.g. “Found order”). In embodiments, edges in the flowgraph may have an “edge_ID” (e.g “E1”) and a tuple with a source node and a target node (e.g., “N1, N2”) and an edge description, such as those described herein. In embodiments, one-shot prompting may be used to provide an example to a given LLM to increase the accuracy and effectiveness of the LLM in generating the flowgraph at block 306. FIGS. 7C-1, 7C-2, and 7C-3 depict portions of an exemplary prompt 730 usable to provide an example flowgraph to an LLM, such that the LLM may use the flowgraph as context to generate the flowgraph as described above at block 306.

At block 308, test dataset generation system 110 generates, using the LLM, a conversation graph based on the generated flowgraph. Referring back to the exemplary automated test dataset generation pipeline 200 (See FIG. 2), the LLM used by test dataset generation system 110 may function as a conversation graph generator (such as conversation generator 260 in FIG. 2) to generate a conversation graph based on the flowgraph (the flowgraph being based on the generated procedures and the extracted APIs). As discussed above, because the flowgraph represents a sequence of agent steps to fulfill the generated procedure, the structure of the flowgraph does not directly map to a conversation. Thus, to arrive at useful test datasets representing extracted conversations, a conversation graph generator (such as conversation graph generator 240 of FIG. 2) of test dataset generation system 110 may be used to convert the flow graph into a conversation graph that is more akin to a dialogue or human conversation.

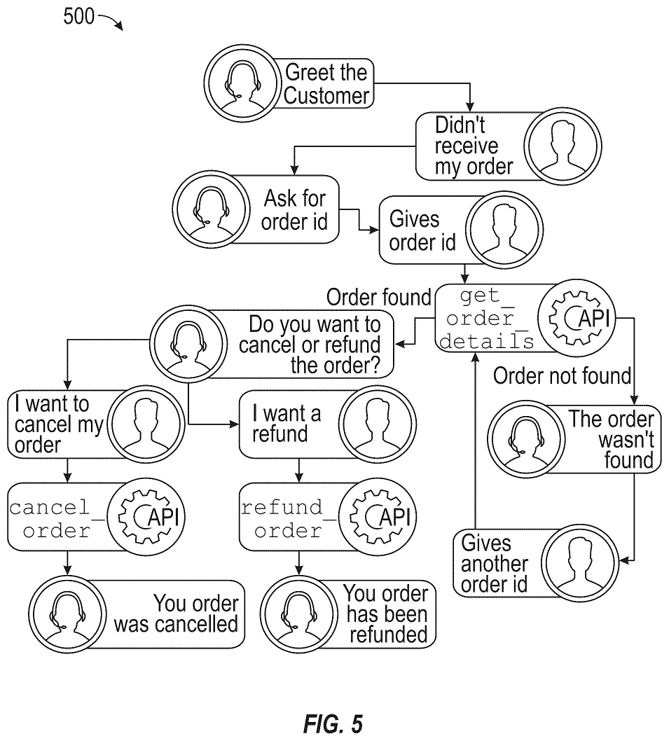

FIG. 5 depicts an exemplary conversation graph 500 that may be generated by an illustrative process of generating test datasets for evaluating LLM agents according to at least one embodiment. The features of the conversation graph generated may be determined by the prompt input into the LLM of the LLM agent. FIGS. 7D-1, 7D-2, and 7C-3 depict portions of an exemplary prompt 740 that may be provided to an LLM to cause the LLM to generate and return exemplary conversation graph as described above. In embodiments, the generated conversation graph may be a directed graph having at least three different node types, such as, for example: (i) “agent nodes” representing messages sent by the LLM agent, (ii) “customer nodes” representing messages sent by the customer, and (iii) “API nodes” representing API calls by the LLM agent. In embodiments, nodes in the conversation graph may have a “node_id” (e.g., “N1”), a “node type” (as previously described), a “node_description”, which may include messages for an LLM agent and customer nodes, and API calls for API nodes. In embodiments, edges in the generated conversation graph may connect consecutive messages or API calls. In embodiments, some conversation paths may have conditions (e.g., such as an API call returning that an order was found or not). If conversation paths include conditions, then edges may have an edge description, or alternatively, have an empty edge description. In embodiments, edges in the flowgraph may have an “edge_id” (e.g. “E1”), a tuple with a source node and a target node (e.g., “(N1, N2)”), and an edge description. In embodiments, additional graph construction rules may be included with the prompt as may be desirable for a given user or developer. Similarly to block 306, in embodiments, the LLM may be provided with an example flowgraph and a corresponding conversation graph to increase its accuracy in generating a conversation graph from a flowgraph.

At block 310, test dataset generation system 110 may insert noise into the conversation graph. In the context of this disclosure, noise refers to any irrelevant, extraneous, or distracting information that can interfere with a virtual agent's ability to understand and respond accurately to a given customer or user. Noise may also cause an LLM, or an LLM agent, to deviate from outlined procedures. Because the conversation graphs generated by test dataset generation system 110 are built from the previously generated procedures at 302, the conversation graphs are only expected to contain accepted behavior or responses by both the agent and the customer (i.e., “happy paths”). Test dataset generation system 110 may add noise to the conversation graph to make the LLM agent more resilient to unexpected customer behavior, thereby expanding the generated conversation graph to also contain behavior that goes outside the initial generated procedures.

In embodiments, test dataset generation system 110 may insert noise into the conversation graph using a noise generator (such as noise generator 280 of FIG. 2) configured to sequentially traverse a set of agent nodes of the generated conversation graph. The graph traversal may be performed, for example, using depth-first search or breadth-first search. The noise generator may be configured to insert an out-of-procedure response for a predetermined percentage (e.g., 20%) of agent nodes. For example, the noise generator may traverse a set of “agent nodes” in the generated conversation graph and, in accordance with a certain predetermined probability (e.g., 20%), determine whether to add noise for each traversed node of the set of agent nodes. In response to determining that noise will be added for a given agent node, the noise generator of the test dataset generation system will prompt the large language model to generate and insert an edge connecting the agent node to a new “customer node” having a “node_description” message which is either an “out-of-procedure” message (e.g., response) or a “nonsense/attack” message. As used herein, “out-of-procedure” refers to a response or message that deviates from an expected conversational flow or structure for a given conversation graph. In embodiments, the noise generator may further add new edges connecting “new customer” nodes to “new agent” nodes with a “node description” containing, for example, “say, sorry but only here to help with the original issue”. Adding this type of noise to the generated conversation graph helps test dataset generation system 110 generate diverse test datasets, which include test scenarios where a customer deviates from the generated procedures, making the resulting generated conversations more realistic and suitable for test datasets. Notably, in some examples, the predetermined percentage of agent nodes may be set to 0%, thereby ensuring no noise is added to the conversation graph.

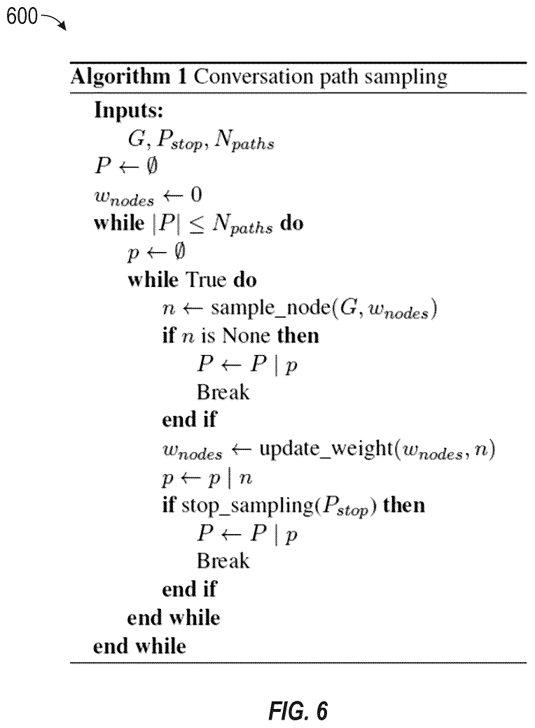

At block 312, test dataset generation system 110 may sample paths from the generated conversation graph. Sampling paths involves building possible conversations by selecting possible paths from the conversation graph representing a conversation between a customer and the LLM agent. In some embodiments, test dataset generation system 110 may be configured to sample paths using random walks. In some embodiments, test dataset generation system 110 may be configured to execute an algorithm for sampling paths, such as the exemplary path sampling algorithm 600 depicted in FIG. 6. Exemplary path sampling algorithm 600 may be configured to, given a conversation graph “G”, sample paths by traversing the graph randomly starting from a root node. To ensure adequate coverage, path sampling algorithm 600 may track visited nodes, increasing the weight of visited nodes (represented as “w_{nodes}”), such that when a next node is visited, the probability of each node is inversely correlated with the weight of the nodes. In exemplary path sampling algorithm 600, the sampling process for a new path may be stopped when the algorithm reaches a leaf node or there is a probability of Pₛₜₒₚ.

At block 314, test dataset generation system 110 generates, using the LLM, conversations based on at least the conversation graph, the extracted APIs, and a series of sampled paths from the generated conversation graph. At this step, test dataset generation system 110 uses the LLM to build synthetic conversations grounded in the generated conversation graph using the APIs. The LLM is also provided with the sampled paths from 312 to guide the expected generation of conversations. In embodiments, one-shot or few-shot prompting may be used to generate the conversations, where the prompt further includes an example of a triplet of conversation graph, a list of APIs, and a sampled path, along with the possible conversations given those conditions. FIGS. 7E-1, 7E-2, and 7E-3 depict portions of an exemplary prompt 750 that may be input into the LLM to cause the LLM to generate and return conversations based on at least the conversation graph, the extracted APIs, and a series of sampled paths from the generated conversation graph. In embodiments, in addition to a comprehensive example, the prompt input into the LLM may further include certain conditions. For example, an illustrative prompt may enforce that the LLM will always generate a message with the API output after an API message, interleave customer and assistant messages, have agents act on API output messages, verify API input and output types, and any other enforceable rules or conditions as may be useful to encourage generation of valid conversations.

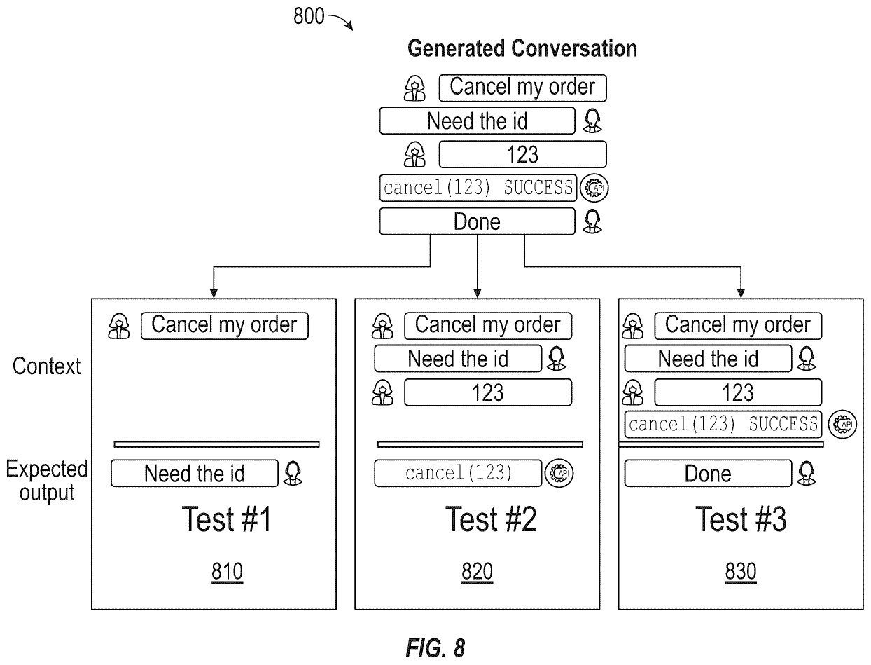

At block 316, test dataset generation system 110 may extract at least one test dataset from the generated conversations. FIG. 8 depicts an exemplary test extraction scheme 800 for an illustrative process of generating test datasets for evaluating LLM agents according to at least one embodiment. As shown, an exemplary test extractor (such as test extractor 140 of FIG. 1, or test extractor 270 of FIG. 2) of test dataset generation system 110 may be used to transform the generated conversations into one or more test datasets. In embodiments, the test extractor may iteratively break the generated conversations into sub-conversations (or context). Each of the sub-conversations may end with a customer message (e.g., “Cancel my order”) or an API output (e.g., “success”, after calling a cancel function). Because the generated conversations from block 314 are expected to include examples of correct flows in view of the target intent, the generated procedures, and the extracted APIs, it is assumed that context may be built using the previous messages, with the expected output being the next non-customer message (e.g., an agent message or an API call). FIG. 8 depicts three exemplary extracted test datasets 810, 820, and 830 respectively. In turn, extracted test datasets 810, 820, and 830 may be used as datasets to evaluate or test an LLM agent by providing the LLM agent with context, obtaining its answer, and comparing it with the expected output. Typically, multiple extracted datasets will be combined to form larger datasets capable of more comprehensive evaluation of a given target LLM agent.

Accordingly, exemplary test dataset generation system 110 may generate high-quality diverse test datasets with good coverage that are grounded in relevant procedures. Exemplary test dataset generation system 110 may be configured to automate the process of generating test datasets. In some embodiments, the exemplary automated test dataset generation pipeline 200 may be seeded with different intents, and may be allowed to use real data used by a given company to generate synthetic conversations. In embodiments, it is envisioned that low-quality data points may be filtered out during the generation process using any suitable known methods (e.g., using automatic filters or human annotations) to ensure the generated datasets maintain high quality. In other embodiments, exemplary test dataset generation system 110 may incorporate red teaming examples where helpful for improved generation of test datasets.

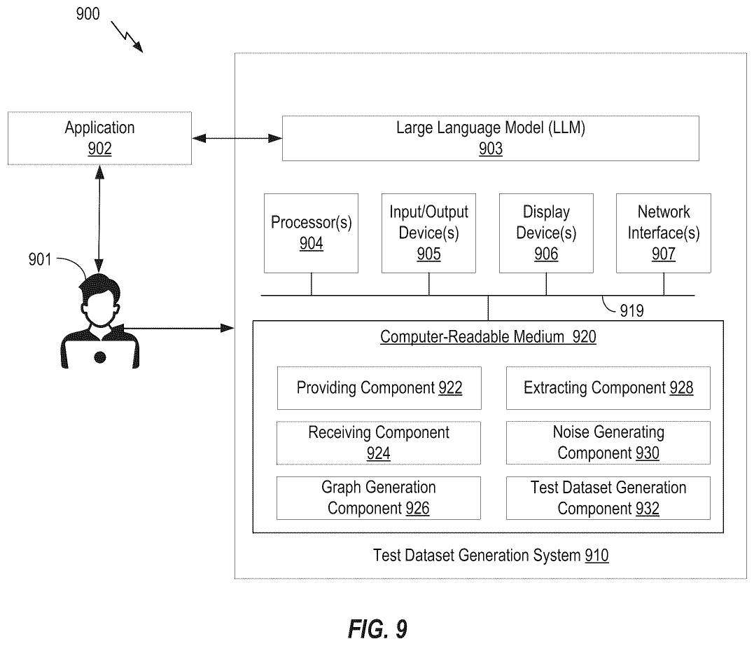

FIG. 9 depicts an example processing system 900 in which an exemplary test dataset generation system 110, as described above, may be implemented.

FIG. 9 includes a test dataset generation system 910 which may be configured to perform various methods as described herein, such as those described herein with respect to FIG. 3. Test dataset generation system 910 may be implemented in an electronic device configured to execute computer-executable instructions, such as those derived from compiled computer code, including, for example, desktop computers, tablet computers, server computers, cloud-based processing devices, and others.

In the depicted example, the test dataset generation system 910 includes one or more processors 904, one or more input/output devices 905, one or more display devices 906, one or more network interfaces 907 through which the test dataset generation system 910 is connected to one or more networks (e.g., a local network, an intranet, the Internet, or any other group of processing systems communicatively connected to each other), and one or more computer-readable media 920. In the depicted example, the aforementioned components are coupled by a bus 919, which may generally be configured for data exchange amongst the components described herein. The bus 919 may be representative of multiple buses, while only one is depicted for simplicity.

The one or more processors 904 are generally configured to retrieve and execute instructions stored in one or more memories, including local memories like the computer-readable media 920, as well as remote memories and data stores. More generally, the bus 919 may be configured to transmit programming instructions and application data among the processors 904, the display devices 906, the network interfaces 907, and/or the computer-readable media 920. In certain embodiments, the processors 904 may be representative of one or more central processing units (CPUs), graphics processing unit (GPUs), tensor processing unit (TPUs), accelerators, and other processing devices.

The input/output devices 905 may include any device, mechanism, system, interactive display, and/or various other hardware and software components for communicating information between the test dataset generation system 910 and a user or operator of the test dataset generation system 910, such as the user or developer 901. For example, the input/output devices 905 may include input hardware, such as a keyboard, touch screen, button, microphone, speaker, and/or other device for receiving inputs from a user and sending outputs to a user.

The display devices 906 may generally include any sort of device configured to display data, information, graphics, user interface elements, and the like to a user. For example, the display devices 906 may include internal and external displays such as an internal display of a tablet computer or an external display for a server computer or a projector. The display devices 906 may further include displays for devices, such as augmented, virtual, and/or extended reality devices. In various embodiments, the display devices 906 may be configured to display a graphical user interface.

The network interfaces 907 may provide the test dataset generation system 910 with access to external networks and thereby to external processing systems. The network interfaces 907 can generally be any hardware and/or software capable of transmitting and/or receiving data via a wired or wireless network connection. Accordingly, the network interfaces 907 may include a communication transceiver for sending and/or receiving any wired and/or wireless communication.

The computer-readable media 920 may be a volatile memory, such as a random access memory (RAM), or a nonvolatile memory, such as nonvolatile random access memory (NVRAM), or the like. In this example, the computer-readable media 920 include at least a providing component 922, a receiving component 924, a graph generation component 926, an extracting component 928, a noise generating component 930, and a test dataset generation component 932.

In embodiments, the providing component 922 is configured to perform functions, such as providing inputs to a large language model 903 in accordance with steps of the above-described methods. For example, the providing component 922 may be configured for providing prompts to large language model 903.

In embodiments, the receiving component 924 is configured to perform functions, such as receiving output from the large language model 903 in accordance with steps of the above-described methods.

In embodiments, the graph generation component 926 is configured to perform functions relating to receiving data related to intermediate graphs generated by large language model 903 in accordance with steps of the above-described methods. For example, graph generation component 926 may be configured to receive data related to one or more of generated flowgraphs and conversations graphs, and output the generated graphs to the user via a suitable user interface (UI) or back through large language model 903 via a suitable UI of an application 902.

In embodiments, the extracting component 928 is configured to perform functions, such as extracting APIs associated with generated procedures in accordance with steps of the above-described methods.

In embodiments, the noise generating component 930 is configured to perform functions, such as generating noise to insert into generated conversation graphs in accordance with steps of the above-described methods.

In embodiments, the test dataset generation component 932 is configured to generate test datasets in accordance with steps of the above-described methods. For example, test dataset generation component may be configured for extracting test datasets from generated conversations in accordance with above-described methods.

FIG. 9 is just one example of a processing environment consistent with embodiments described herein, and other processing systems having additional, alternative, or fewer components are possible consistent with this disclosure.

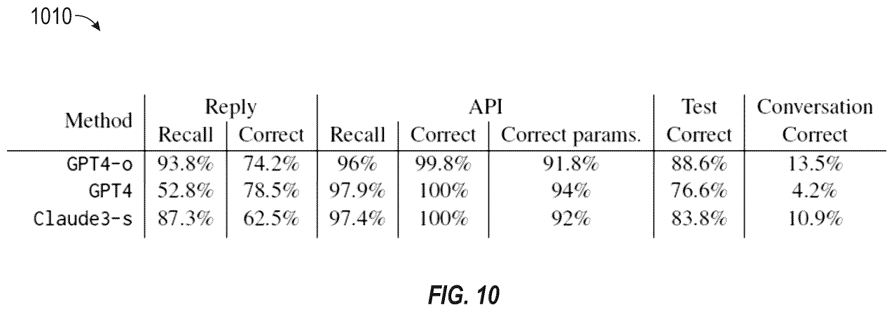

FIG. 10 depicts a table 1010 including evaluation results for a series of LLMs employed as LLM agents using test datasets generated via an illustrative process of generating test datasets for evaluating LLM agents according to at least one embodiment. In embodiments, test datasets generated using described methods may be filtered to varying extents before evaluating a given LLM agent. Filtering may include manual annotation, automatic filtering using suitable heuristics, or any other suitable methods of filtering at various stages of the above-described methods. For example, manual annotation may be used to filter out generated procedures (e.g., at block 302 of FIG. 3), that do not comply with certain rules, while automatic filtering using desired sets of heuristics may be used to filter out APIs (e.g., at block 304 of FIG. 3), that are invalid.

Table 1010 includes evaluation results which measured seven different evaluation metrics. “Reply Recall” evaluates whether a given LLM agent correctly sent a reply message instead of calling an unnecessary API. “Reply Correct” evaluates whether a given LLM agent's reply matches the expected reply. This may involve, for example, the use of a BERTscore with a threshold of 0.55 to discriminate similarity. “API Recall” evaluates whether the agent correctly detected that it needed to perform an API call instead of replying. “API Correct” evaluates whether an API call was correct. “API Correct Parameters” evaluates whether the API was called with correct parameter values. “Test Correct” evaluates whether the test is fully correct (i.e., call the correct reply and/or API and, if the correct action is an API, call the correct API and use the correct parameters). “Conversation Correctness” evaluates whether the sequence of all tests from the conversation were all correct. The evaluation metrics depicted in table 1010 are merely illustrative, and may be substituted or added to with any suitable evaluation metrics.

### EXAMPLE CLAUSES

Implementation examples are described in the following numbered clauses:

Clause 1: A method of generating a set of test datasets for evaluating large language model agents, the method comprising: extracting, using a large language model, application programming interfaces (APIs) associated with procedures for one or more target intents; generating, using the large language model, a flowgraph based on the APIs and the procedures for the one or more target intents; generating, using the large language model, a conversation graph based on the flowgraph; generating, using the large language model, conversations based on at least the conversation graph, the APIs, and a series of sampled paths from the conversation graph; and extracting the set of test datasets from the conversations.

Clause 2: The method in accordance with clause 1, prompting the large language model to generate procedures for the one or more target intents prior to extracting the APIs, wherein the one or more target intents are provided to the large language model within a prompt.

Clause 3: The method in accordance with Clause 1, wherein procedures for the one or more target intents are provided to the large language model prior to extracting the APIs.

Clause 4: The method in accordance with any of Clauses 1-3, further comprising inserting noise into the conversation graph by: sequentially traversing a set of agent nodes of the conversation graph to determine, in accordance with a predetermined probability, whether to insert the noise into the conversation graph for an agent node of the set of agent nodes; and in response to determining to insert the noise into the conversation graph for the agent node of the set of agent nodes, prompting the large language model to generate and add, to the conversation graph, an out-of-procedure response for the agent node.

Clause 5: The method in accordance with any of Clauses 1-4, wherein the APIs comprise agent APIs callable by an agent to fulfill one or more of the procedures for the one or more target intents.

Clause 6: The method in accordance with any of Clauses 1-5, wherein generating, using the large language model, the flowgraph based on the APIs and the procedures, further comprises instructing the large language model to include the procedures in a series of message nodes.

Clause 7: The method in accordance with any of Clause 1-6, wherein generating the series of sampled paths from the conversation graph further comprises: randomly traversing nodes of the conversation graph starting from a root node; and iteratively increasing a weight of a series of visited nodes until a leaf node is reached.

Clause 8: The method in accordance with any of Clause 1-7, wherein the conversations are generated by one-shot prompting or few-shot prompting of the large language model based on the flowgraph and the conversation graph.

Clause 9: The method in accordance with any of Clause 1-8, wherein extracting the set of test datasets from the conversations further comprises: iteratively dividing the conversations into a set of sub-conversations, wherein each sub-conversation of the set of sub-conversations ends with one of a customer message or an API output, wherein an expected output for each sub-conversation of the set of sub-conversations comprises one of an agent message or an API call.

Clause 10: A processing system, comprising means for performing a method in accordance with any one of Clauses 1-9.

Clause 11: A non-transitory computer-readable medium storing program code for causing a processing system to perform the steps of a method in accordance with any one of Clauses 1-9.

Clause 12: A computer program product embodied on a computer-readable medium comprising program code for performing a method in accordance with any one of Clauses 1-9.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of generating a set of test datasets for evaluating large language model agents, the method comprising:
extracting, using a large language model, application programming interfaces (APIs) associated with procedures for one or more target intents;
generating, using the large language model, a flowgraph based on the APIs and the procedures for the one or more target intents;
generating, using the large language model, a conversation graph based on the flowgraph;
generating, using the large language model, conversations based on at least the conversation graph, the APIs, and a series of sampled paths from the conversation graph; and
extracting the set of test datasets from the conversations.

2. The method of claim 1, further comprising prompting the large language model to generate the procedures for the one or more target intents prior to extracting the APIs, wherein the one or more target intents are provided to the large language model within a prompt.

3. The method of claim 1, wherein the procedures for the one or more target intents are provided to the large language model prior to extracting the APIs.

4. The method of claim 1 further comprising inserting noise into the conversation graph by:
sequentially traversing a set of agent nodes of the conversation graph to determine, in accordance with a predetermined probability, whether to insert the noise into the conversation graph for an agent node of the set of agent nodes; and
in response to determining to insert the noise into the conversation graph for the agent node of the set of agent nodes, prompting the large language model to generate and add, to the conversation graph, an out-of-procedure response for the agent node.

5. The method of claim 1, wherein the APIs comprise agent APIs callable by an agent to fulfill one or more of the procedures for the one or more target intents.

6. The method of claim 1, wherein generating, using the large language model, the flowgraph based on the APIs and the procedures, further comprises instructing the large language model to include the procedures in a series of message nodes.

7. The method of claim 1, wherein generating the series of sampled paths from the conversation graph further comprises:
randomly traversing nodes of the conversation graph starting from a root node; and
iteratively increasing a weight of a series of visited nodes until a leaf node is reached.

8. The method of claim 1, wherein the conversations are generated by one-shot prompting or few-shot prompting of the large language model based on the flowgraph and the conversation graph.

9. The method of claim 1, wherein extracting the set of test datasets from the conversations further comprises:
iteratively dividing the conversations into a set of sub-conversations, wherein each sub-conversation of the set of sub-conversations ends with one of a customer message or an API output,
wherein an expected output for each sub-conversation of the set of sub-conversations comprises one of an agent message or an API call.

10. A processing system, comprising:
one or more memories comprising computer-executable instructions; and
one or more processors configured to execute the computer-executable instructions causing the processing system to:
extract, using a large language model, application programming interfaces (APIs) associated with procedures for one or more target intents;
generate, using the large language model, a flowgraph based on the APIs and the procedures for the one or more target intents;
generate, using the large language model, a conversation graph based on the flowgraph;
generate, using the large language model, conversations based on at least the conversation graph, the APIs, and a series of sampled paths from the conversation graph; and
extract a set of test datasets from the conversations.

11. The processing system of claim 10, wherein the one or more processors are further configured to cause the processing system to prompt the large language model to generate the procedures for the one or more target intents prior to extracting the APIs, wherein the one or more target intents are provided to the large language model within a prompt.

12. The processing system of claim 10, wherein the procedures for the one or more target intents are provided to the large language model within a prompt prior to extracting the APIs.

13. The processing system of claim 10, wherein the one or more processors are further configured to cause the processing system to insert noise into the conversation graph by prompting the large language model to generate an out-of-procedure response for a percentage of agent nodes.

14. The processing system of claim 10, wherein the APIs comprise agent APIs callable by an agent to fulfill one or more of the procedures for the one or more target intents.

15. The processing system of claim 10, wherein to generate, using the large language model, the flowgraph based on the APIs and the procedures, the one or more processors are further configured to cause the processing system to instruct the large language model to include the procedures in a series of message nodes.

16. The processing system of claim 10, wherein to generate the series of sampled paths from the conversation graph, the one or more processors are further configured to cause the processing system to:
randomly traverse nodes of the conversation graph starting from a root node; and
iteratively increase a weight of a series of visited nodes until a leaf node is reached.

17. The processing system of claim 10, wherein the conversations are generated by one-shot prompting or few-shot prompting of the large language model based on the flowgraph and the conversation graph.

18. The processing system of claim 10, wherein to extract the set of test datasets from the conversations, the one or more processors are further configured to cause the processing system to:
iteratively divide the conversations into a set of sub-conversations, wherein each sub-conversation of the set of sub-conversations ends with one of a customer message or an API output, wherein an expected output for each sub-conversation of the set of sub-conversations comprises one of an agent message or an API call.

19. A non-transitory computer-readable medium storing program code for causing a processing system to perform a method, the method including:
generating, using a large language model, procedures for one or more target intents;
extracting, using the large language model, application programming interfaces (APIs) associated with the procedures for the one or more target intents;
generating, using the large language model, a flowgraph based on the APIs and the procedures for the one or more target intents;
generating, using the large language model, a conversation graph based on the flowgraph;
generating, using the large language model, conversations based on at least the conversation graph, the APIs, and a series of sampled paths from the conversation graph; and
extracting a set of test datasets from the conversations.

20. The non-transitory computer-readable medium of claim 19, wherein the method further includes inserting noise into the conversation graph by prompting the large language model to generate an out-of-procedure response for a percentage of agent nodes.
